(19) United States
(12) Patent Application Publication
(10) Pub. No.: US 2005/0139192 A1
(43) Pub. Date: Jun. 30, 2005

(54) Piston engine, especially reciprocating internal combustion engine with additional charge control mechanism

(76) Inventor: Martin Lechner, Stuttgart (DE)

Correspondence Address: WILLIAM COLLARD;COLLARD & ROE, P.C., 1077 NORTHERN BOULEVARD, ROSLYN, NY, 11576, US

(21) Appl. No.: 10/511,219

(22) PCT Filed: Oct. 29, 2003
(86) PCT No.: PCT/DE03/03605

(30) Foreign Application Priority Data
Nov. 9, 2002 (DE) 102 52 208.1

(51) Int. Cl. F02D 9/02

(52) U.S. Cl. 123/336; 123/184.52

(57) ABSTRACT

Disclosed is a piston engine, especially a reciprocating internal combustion engine comprising: —a working space that is controlled by main valves; —a charge channel leading to at least one of the main valves; a section of the charge channel, which is split into at least two parallel charge channel paths; and—at least one additional valve that is disposed inside each of the two parallel charge channel paths and controls the portion of the charge volume flow penetrating the path. The additional valves are embodied as rotary slide valves which rotate in a single direction when the engine is operated. The volume throughputs of the main valves and additional valves as well as the volume throughputs among the additional valves can be variably coordinated.

This invention relates to a piston engine, in particular a reciprocating internal combustion engine having an additional charge control mechanism according to the definition of the species of patent claim 1.

Such a device is known from U.S. patent 2002/0005158 A1. The additional valves there are designed as oscillating leaf valves and/or flap valves. Oscillating drives basically cause problems at high frequencies because of the required deceleration and acceleration. In the case of high-speed combustion engines in particular, these problems cannot be overcome, at least not without a great expense in terms of equipment or at least with sufficient operating reliability.

Against this background, the present invention is concerned with the problem of making available additional valves that are more suitable for the generic application purpose.

This problem is solved with a generic reciprocating engine by using a design of the additional valves according to the characterizing features of patent claim 1.

Expedient and advantageous embodiments are the object of the subclaims.

An additional valve in the form of a rotary slide valve inserted into the intake tract of an internal combustion engine to provide additional charge control is already known from German Patent DE 26 21 362 A1. The possibilities for additional charge control are limited due to a lack of division of a charge channel region into two parallel charge channel paths with at least one rotary slide provided for each path in that embodiment. Thus, with a charge channel having parallel flow paths that are not guided in parallel in some regions, for example, and where each is provided with an additional control valve, it is impossible to vary the closing times and opening times independently of each other because their assignment depends on the invariable geometry of the rotary slide as well as the invariable geometry of the control edges of the rotary slide valve on the housing end.

This invention is based on the general idea of achieving almost any control possibilities for the charge volume flow through phase displacement of the rotational movement of the rotary slide in the rotary slide valves by means of a division of the charge channel into two flow paths running in parallel to one another in some regions, with a rotary slide valve being provided in each path.

Such an inventive charge control variability cannot be achieved in particular with a device according to Japanese Patent JP 22 41 925, in which an additional valve in the form of a rotary slide valve having two rotary slides meshing concentrically with one another is used in an undivided charge channel.

Exemplary embodiments of the present invention are illustrated in the drawing and explained in greater detail below along with various possible additional charge controls.

The figures show the following:

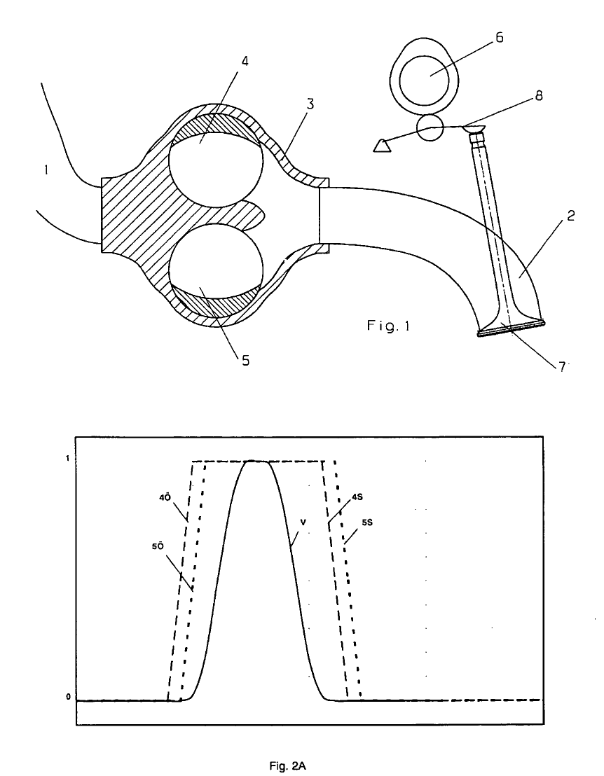

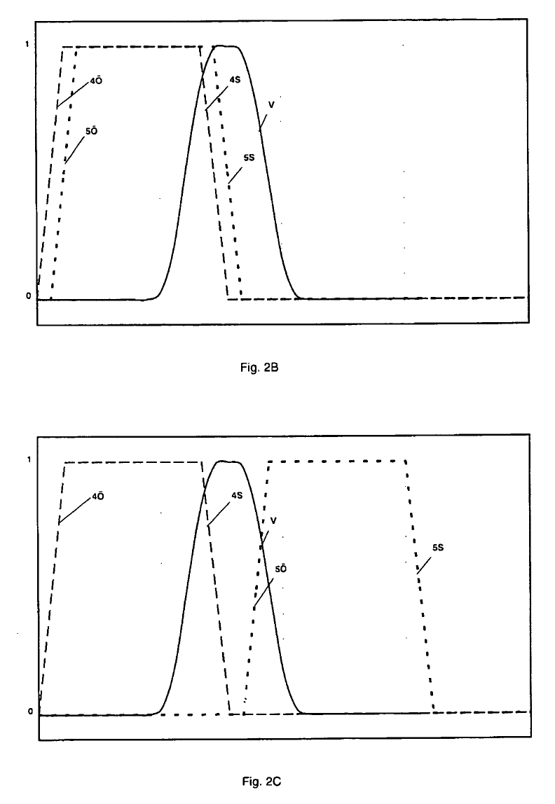

FIG. 1 a schematic, partially cutaway view of a charge channel with a parallel flow region having an additional rotary slide valve in each of the two partial flow regions,

FIGS. 2A-D charge control diagrams with reference to a working space that is to be filled,

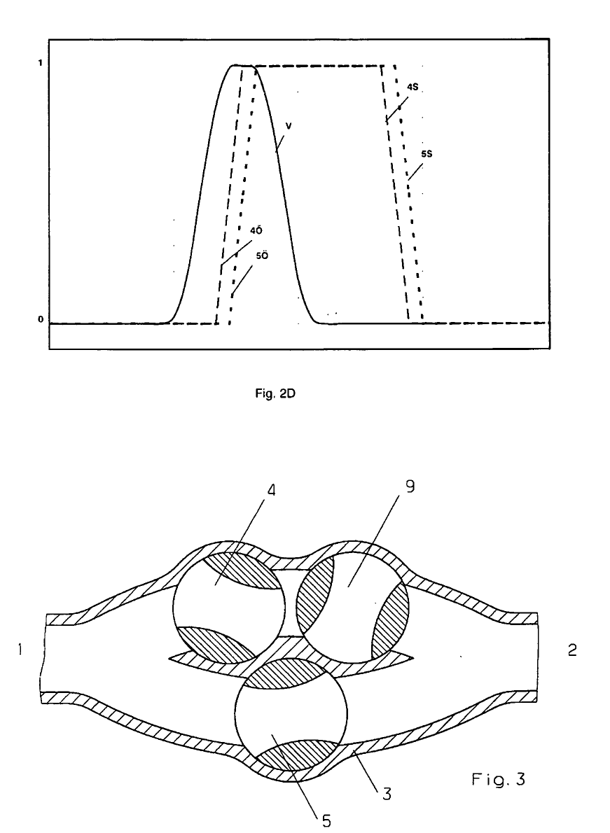

FIG. 3 a charge channel in a basic design according to FIG. 1 in which two rotary slide valves are arranged in a row, in contrast with the embodiment in FIG. 1, where these valves are provided in one of the two parallel flow paths,

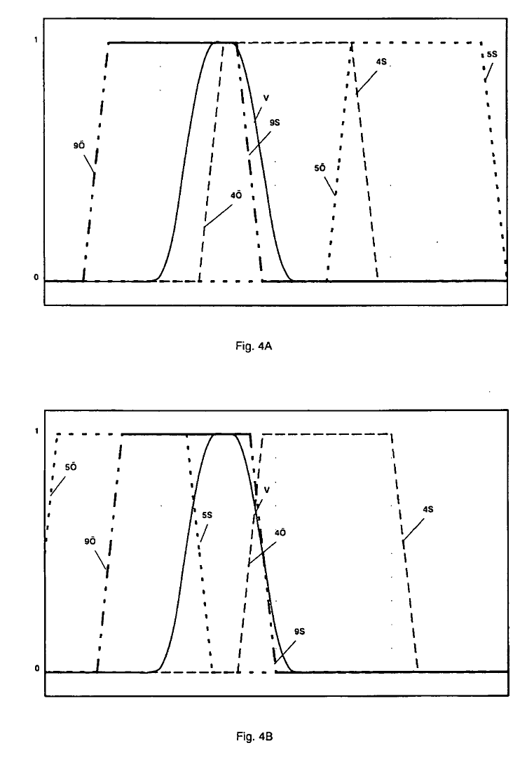

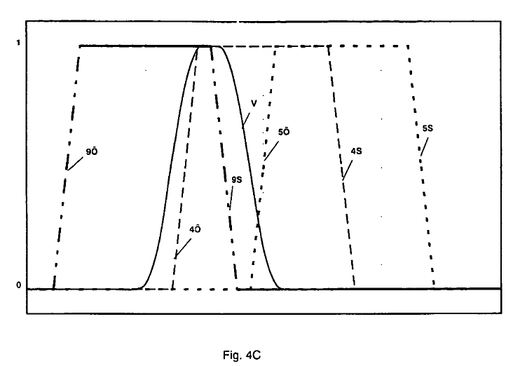

FIGS. 4A-4C charge control diagrams that can be achieved with a device according to FIG. 3 in contrast with that according to FIG. 1.

FIG. 1 shows an example of a charge channel of a reciprocating internal combustion engine with an intake manifold 1, a charge channel 2 leading into the working space of the internal combustion engine and a region 3 of the charge channel 2 having two parallel flow paths, each of which has a rotary slide valve 4, 5 as an additional control valve. The connection of the intake manifold 1 with the parallel flow paths within the region 3 of the charge channel 2 is not shown in this drawing. The drive of the rotary slides inside the rotary slide valves 4 and 5 is also not shown here. Essentially the rotary slides of the rotary slide valves 4 and 5 can be driven by the crankshaft (not shown) of the internal combustion engine at the rotational speed of the camshaft 3 acting on a main valve 7 controlling the working space of the internal combustion engine. The main valve 7 is an intake valve for the respective working space of the internal combustion engine in which a piston oscillates in a reciprocating piston engine. The rotary slides of the rotary slide valves 4, 5 may rotate in phase opposition with one another and with the phase angle of the camshaft 6, to which end conventional essentially known phase displacement devices are to be incorporated into the drive. The camshaft 6 acts on the main valve 7 via a lever 8, for example.

The individual diagrams in FIG. 2 each show schematically an intake valve lift (V) as a function of the crankshaft angle of rotation of an internal combustion engine as well as the opening and closing times for the two rotary slides (40, 50, 4S, 5S) for a respective engine cylinder as the working space. This diagram shows the number 1 plotted on the ordinate as denoting a completely open cross section and 0 denoting a closed cross section.

The operating point depicted in the diagram in FIG. 2A corresponds to a functionless state of the additional control valves designed as rotary slides 4, 5. Such an operating point may be desired at the maximum power point, for example, depending on the design of the intake system.

A functionless state of the rotary slides 4, 5 as additional control valves means that there is rotation of the rotary slides, causing a flow state within the charge channel 2 such as that which would prevail in the complete absence of additional control valves. Such a possible behavior of the inventive additional control valves is a particular advantage of the present invention.

FIG. 2B shows a state in which an early intake closing (FES) mode of operation is shifted toward early by the phase adjustment of the rotary slides 4, 5 with respect to the camshaft 6; in this operating mode, the charge quantity is adjusted without the throttle only via the closing points in time of the rotary slide valves 4, 5. For the middle and lower rotational speed ranges, an increase in the full-load torque can also be achieved with early intake closing. A further increase in torque is also possible by briefly interrupting the intake process as depicted in FIG. 2C. Hindering the flow generates a vacuum on the combustion chamber end and a back-pressure on the intake manifold end, which in turn jointly produces a higher-cylinder charge, i.e., a higher operating space charge-when reopened jointly than would be the case with intake without an optimized closing point for the intake valve; this is comparable to the effect of an air cycle valve (LTV).

FIG. 2D shows schematically the opening and closing times for operation of a late intake opening (SEO) mode.

Due to the use of two series-connected rotary slide valves 4, 9 in one of the two parallel flow paths within the charge channel 2, as diagramed schematically in FIG. 3, operating modes as illustrated in the charge control diagrams in FIG. 4 can be implemented.

The rotary slides of the rotary slide valves shown in FIG. 3 rotate at half the camshaft rotational speed and are phase adjustable with respect to the camshaft 6 independently of one another. A combination of late intake opening and early intake closing can be achieved by keeping the rotary slide valve 5 closed and by a suitable phase adjustment of the slides of the rotary slide valves 4 and 9. This is diagramed in FIG. 4A. FIG. 4B shows a charge control diagram for a cycled intake process with additional closing after the first intake process. FIG. 4C shows a combination of late intake opening and a cycled intake process.

Through a suitable phase adjustment, any intake opening times and operating times can be implemented. Improvements are possible with the various operating modes of piston engines, such as internal combustion engines in two-cycle and four-cycle operation, Otto, diesel, gas, Miller, Atkinson, HCCI, free intake and supercharged operation are possible.

1. A piston engine, in particular a reciprocating internal combustion engine, comprising
a working space controlled by main valves,
a charge channel leading to at least one of the main valves,
a region of the charge channel divided into at least two parallel charge channel paths,
and at least one additional valve controlling that portion of the charge volume flow in each of the two parallel charge channel paths
wherein
the additional valves are designed as rotary slide valves (4, 5, 9) rotating in one direction during operation of the machine,
the volume flow of the main valves and additional valves (7; 4, 5, 9) on the other hand and the additional valves (4, 5, 9) with respect to one another on the other hand are adjustable so they are mutually variable in relation to one-another.

2. The device according to claim 1,
wherein
at least two rotary slide valves (4, 9) are provided and are connected in series in one of the parallel paths of the charge channel (2).

3. The device according to claim 1,
wherein
the rotary slide valves (4, 5, 9) rotate in synchronization with the movement of the piston.

4. The device according to claim 1, wherein the crankshaft of the reciprocating engine serves as a driving source for the rotary slide valves (4, 5, 9).
